(19) United States
(12) Patent Application Publication
(10) Pub. No.: US 2018/0232530 A1
(43) Pub. Date: Aug. 16, 2018

(54) Methods and Systems for a Frictionless Login to a Service

(71) Applicant: FACEBOOK, INC., Menlo Park, CA (US)

(72) Inventors: Calvin Tsun-Lam Mak, Seattle, WA (US); Ravit Cohen, San Francisco, CA (US); Ethan Goldman-Kirst, Seattle, WA (US); Derek Chirk Yin Cheng, Issaquah, WA (US)

(21) Appl. No.: 15/430,267

(22) Filed: Feb. 10, 2017

(51) Int. Cl. G06F 21/62; G06F 21/60; H04L 29/06

(52) U.S. Cl. CPC G06F 21/6218; H04L 63/083; G06F 21/602

(57) ABSTRACT

Methods, systems, and/or devices for providing a frictionless login experience are described herein. In one aspect, a user is allowed to log into a first service using an account associated with a second service by providing the first service with an identifier, such as an email address or phone number. The second service authenticates the user based on the identifier and other information stored on the user's device. Accordingly, the user does not need to enter a password or other confidential information.

### TECHNICAL FIELD

The disclosed implementations relate generally to logging into Internet services and more specifically to logging into one service using data for (e.g., an account from) another service.

### BACKGROUND

Traditionally, web sites were “static,” meaning that content was placed on the web sites and it would be viewed by any user who went to the web site. As e-commerce grew, web site owners recognized that they could offer enhanced services by allowing for different content to logged-in users. Further, as web sites became more interactive, there became a need for a user to be able to personally interact with a website in such a way that the website distinguished the user from other users of the website. For example, a game that records high scores would need to know which user's name to print on the scoreboard. For another example, a news site that permitted commentary on its stories may wish to identify those commenting to both place the correct names alongside the comments and also to prevent “troll” users from posting inappropriate comments. Further, website owners recognized that by providing personalized content, they could create a new revenue stream whereby users may pay for access to certain features of the site not accessible to non-paying users.

To allow for different content, websites began supporting user accounts. Such accounts often are associated with a username or identifier and may be protected with a password. While this technique worked, it required users to create accounts on numerous websites. Accordingly, users either had to remember many different passwords, which is difficult, or would use the same password on multiple sites, which can lead to security concerns if one of the sites is compromised. Further, as more sites became interactive, it became desirable to associate users from multiple sites. For example, it would be helpful to know if the John Smith scoring high at one game was also the John Smith scoring high on others. But, because these were separate accounts, that could not be readily determined.

To avoid the problems with password management, security, and user association, many websites started allowing common logins. For example, an entity for which a large portion of a site's users already have accounts on (such as a popular social media or email hosting entity) may permit other sites (such as smaller sites like games and news media sites) to permit the use of the entity's accounts by the smaller site. Accordingly, if a user logs into two sites using the same account from the social media company, it can readily be determined that the user on the two sites is the same user. Additionally, by offloading password and user management to a large entity, the smaller sites can focus on what they do best.

One problem that occurs when common or shared accounts are used is that some users may not feel comfortable entering a username and password from one site on another. For example, a user may sufficiently “trust” a gaming site's security to allow the user to play the games on the site, but may not trust it to reliably re-transmit a user's email password to the email hosting entity. This problem is compounded by the fact that many web “sites” are now “apps,” wherein the user will install an app (such as a game or a newspaper reading app) on a device, such as a smartphone, and will access the content via the app as opposed to through the website. While many users may be willing to enter their username and password for a large social media or email hosting company on a website (where browser security may offer some protection), users do not know if an “app” might steal their account information. Accordingly, despite the benefits of using common accounts, many users still create numerous accounts on separate sites and manage their passwords individually.

### SUMMARY

Accordingly, there is a need for methods and systems to allow for a frictionless login (i.e., a user-friendly login involving little user input) into web services (both websites and “apps”) using data from (e.g., a common account hosted by) another entity, such that a user will not need to enter a password or authorization on a website or app in order to log into the website or app.

Thus, in accordance with some implementations, a method is performed on a client device having one or more processors and memory storing instructions for execution by the one or more processors. The method includes receiving, in an application, a request to authenticate a user of the application to a first service. The request includes an identifier associated with the user and does not include an authenticating credential. The method further includes, in response to the request, transmitting the identifier to the first service and requesting the first service to authenticate the user based on the identifier and data stored on the client device. The first service cannot access the data through the application, and the data is associated with the user and a second service distinct from the first service. The method further includes, in response to the requesting, receiving a request for the data from the second service and providing the data to the second service. The method further includes, in response to providing the data to the second service, receiving, in the application, access to a feature of the first service.

In accordance with some implementations, a client system includes one or more processors and memory storing one or more programs configured to be executed by the one or more processors. The one or more programs include instructions for performing the operations of the method described above. In accordance with some implementations, a non-transitory computer-readable storage medium has stored therein instructions that, when executed by the system, cause the system to perform the operations of the method described above.

Thus, users will be able to log into a web service (e.g., both through a website and through an app) using an account hosted by another entity, without having to enter their password or an authentication code.

### BRIEF DESCRIPTION OF THE DRAWINGS

The implementations disclosed herein are illustrated by way of example, and not by way of limitation, in the figures of the accompanying drawings. Like reference numerals refer to corresponding parts throughout the drawings and specification.

FIG. 1 is a block diagram illustrating an exemplary network architecture in accordance with some implementations.

FIG. 2 is a block diagram illustrating an exemplary client device in accordance with some implementations.

FIG. 3 is a block diagram illustrating an exemplary server system in accordance with some implementations.

FIG. 4 is a block diagram illustrating an exemplary communication method between a first service server system, a second service server system, and a client device, in accordance with some implementations.

FIGS. 5A and 5B illustrate exemplary graphical user interfaces (GUIs) on a client device for logging into a service using an account from another service, in accordance with some embodiments.

FIGS. 6A-6D are flow diagrams illustrating a method of providing a frictionless login into a first service using data for (e.g., an account associated with) a second service, in accordance with some implementations.

### DETAILED DESCRIPTION

Reference will now be made to implementations, examples of which are illustrated in the accompanying drawings. In the following description, numerous specific details are set forth in order to provide an understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

It will also be understood that, although the terms first, second, etc. are, in some instances, used herein to describe various elements, these elements should not be limited by these terms. These terms are used only to distinguish one element from another. For example, a first service could be termed a second service, and, similarly, a second service could be termed a first service, without departing from the scope of the various described implementations. The first service and the second service are both services, but they are not the same service.

The terminology used in the description of the various implementations described herein is for the purpose of describing particular implementations only and is not intended to be limiting. As used in the description of the various described implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

As used herein, the term “exemplary” is used in the sense of “serving as an example, instance, or illustration” and not in the sense of “representing the best of its kind.”

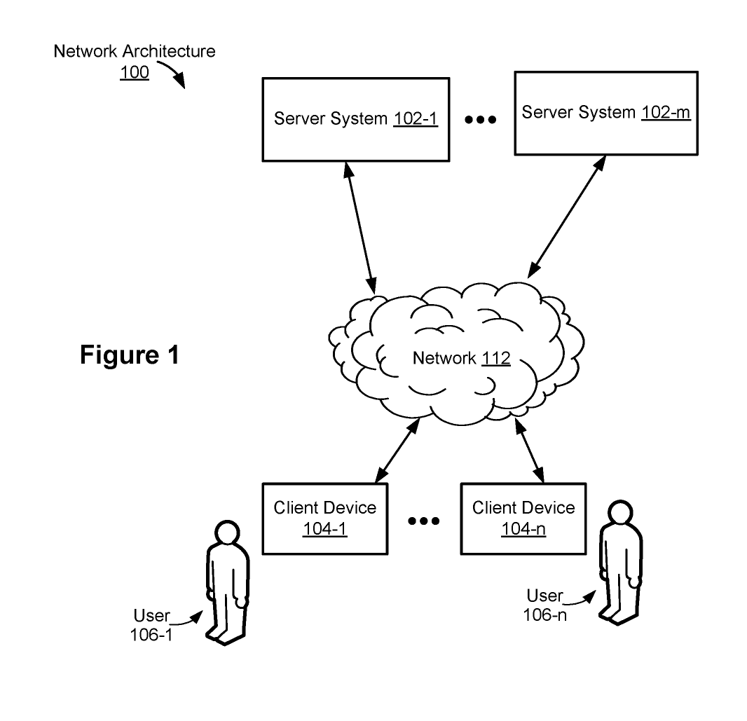

FIG. 1 is a block diagram illustrating an exemplary network architecture 100 in accordance with some implementations. The network architecture 100 includes one or more client devices (“clients”) 104-1 . . . 104-n (where n is an integer greater than or equal to one) and one or more server systems 102-1 through 102-m (where m is an integer greater than or equal to one). One or more networks 112 communicably connect each component of the network architecture 100 with other components of the network architecture 100. In some implementations, the one or more networks 112 include public communication networks, private communication networks, or a combination of both public and private communication networks. For example, the one or more networks 112 can be any network (or combination of networks) such as the Internet, other wide area networks (WAN), local area networks (LAN), virtual private networks (VPN), metropolitan area networks (MAN), peer-to-peer networks, and/or ad-hoc connections.

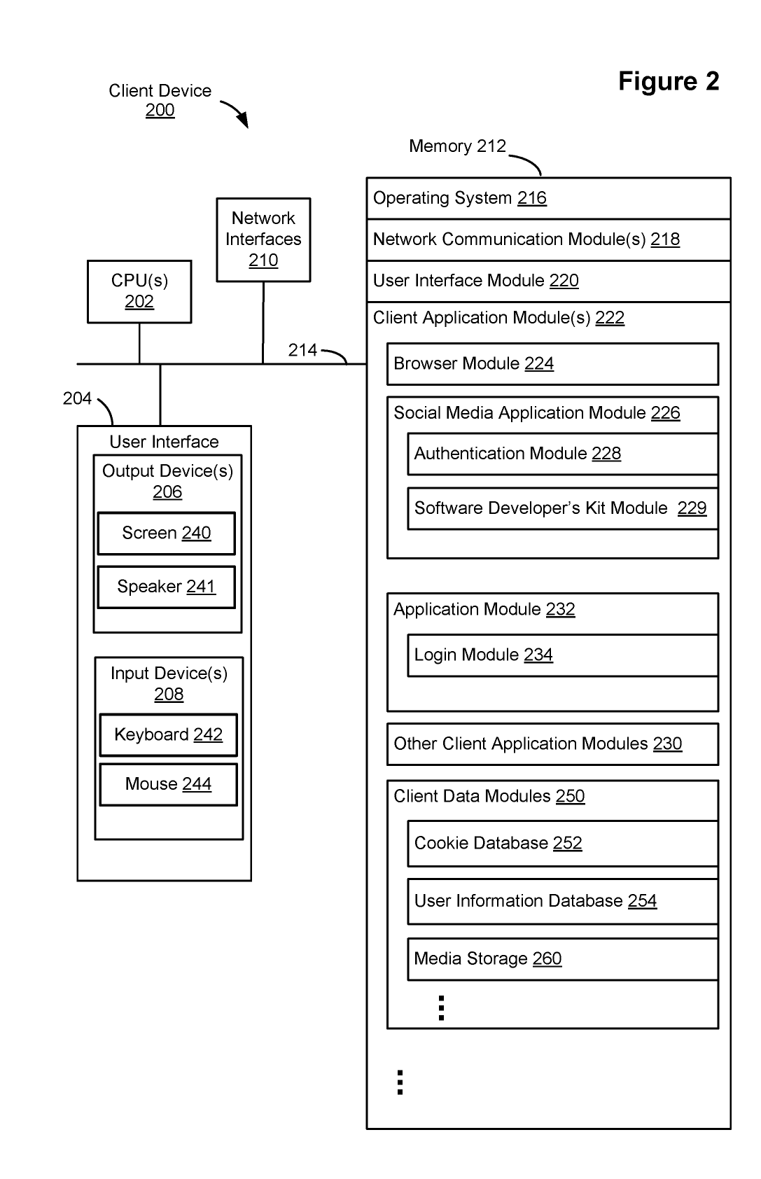

A client 104 (e.g. 104-1, . . . 104-n) is associated with one or more users 106 (e.g., 106-1, . . . 106-n). In some implementations, a client 104 is a personal computer, a mobile electronic device, a wearable computing device, a laptop, a tablet computer, a mobile phone, a feature phone, a smart phone, a digital media player, or any other device capable of capturing and/or transmitting data. In some implementations, clients 104 include input devices 208 (FIG. 2) for receiving user inputs (e.g., touch screens, keyboards or mice for receiving a phone number or email address, which the clients may store and/or transmit to other components of the network architecture 100, such as a server system 102). Clients 104 may be the same type of device (e.g., all mobile devices), or may comprise different types of devices. Users 106 employ clients 104 to execute functions such as logging into a site or app.

In some embodiments, a client 104 sends a function request to a server system 102, which performs the requested function, and the client displays the result. For example, the request may ask a first service to log the user in using an account associated with a second service. After the login process is complete, the client 104 indicates that the user is logged in. In some embodiments, the server system 102 (e.g., a server 102-1) will, in response to receiving the request, send a second request to a second server (e.g., a server 102-m) to perform a function, such as authenticating a user based on an email address or phone number. The clients 104 may access the server systems 102 via network 112. For example, in some embodiments, a client 104 executes a web browser application that can be used to access a service hosted by a server system 102. For another example, in some embodiments, the client 104 executes a software application that is specific to the service (e.g., an “app” running on a smart phone, tablet, or other device).

In some embodiments, the server system 102 stores and provides content, via the network(s) 112, to the users 106 via the client 104. Content stored and served by the server system 102, in some implementations, includes lists of functions, user data, and content necessary to perform the functions. For example, a news service may provide news-related content to the user based on information stored in a profile associated with the user.

The description of the server system 102 as a “server” is intended as a functional description of the devices, systems, processors, and/or other components that provide the functionality attributed to the server system 102. It will be understood that the server system 102 may be a single server computer or multiple server computers. The server system 102 may be coupled to other servers and/or server systems, or other devices, such as other user devices, databases, content-delivery networks (e.g., peer-to-peer networks), network caches, and the like. In some embodiments, the server 102 may communicate with other unaffiliated servers. In some implementations, the server system 102 is implemented by multiple computing devices working together to perform the actions of a server system (e.g., cloud computing).

FIG. 2 is a block diagram illustrating an exemplary client device 200 (e.g., client 104-1, . . . 104-n, FIG. 1) in accordance with some implementations. The client device 200 typically includes one or more central processing units (CPU(s), e.g., processors or cores) 202, one or more network (or other communications) interfaces 210, memory 212, and one or more communication buses 214 for interconnecting these components. The communication buses 214 optionally include circuitry (sometimes called a chipset) that interconnects and controls communications between system components.

As also shown in FIG. 2, the client device 200 includes a user interface 204, including output device(s) 206 and input device(s) 208. In some implementations, the input devices 208 include a keyboard 242 or mouse 244. Alternatively, or in addition, the user interface 204 includes one or more output devices 206 (such as screen 240) that may include a touch-sensitive surface, in which case the output device 206 also functions as an input device 208. In user devices that have a touch-sensitive output device, a physical keyboard is optional (e.g., a soft keyboard may be displayed when keyboard entry is needed). Furthermore, some user devices 102 use a microphone and voice recognition device to supplement or replace the keyboard. Furthermore, some user devices 102 employ other output devices 206 such as speakers 241 to supplement or replace the screen 240.

In some implementations, the one or more network interfaces 210 include wireless and/or wired interfaces for receiving data from and/or transmitting data to a server system 102 and/or other devices or systems. In some implementations, data communications are carried out using any of a variety of custom or standard wireless protocols (e.g., NFC, RFID, IEEE 802.15.4, Wi-Fi, ZigBee, 6LoWPAN, Thread, Z-Wave, Bluetooth, ISA100.11a, WirelessHART, MiWi, etc.). Furthermore, in some implementations, data communications are carried out using any of a variety of custom or standard wired protocols (e.g., USB, Firewire, Ethernet, etc.). For example, in some implementations, the one or more network interfaces 210 includes a wireless LAN (WLAN) interface for enabling data communications with the server system 104 (via the one or more network(s) 112, FIG. 1).

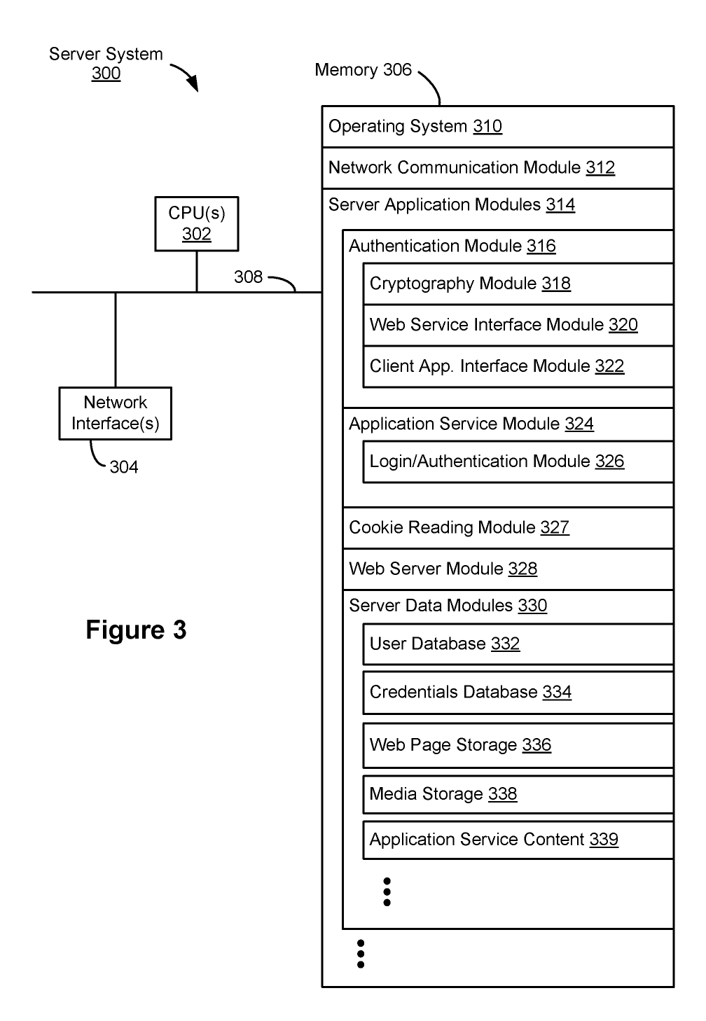

Memory 212 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 212 may optionally include one or more storage devices remotely located from the CPU(s) 202. Memory 212, or alternately, the non-volatile memory solid-state storage devices within memory 212, includes a non-transitory computer-readable storage medium. In some implementations, memory 212 or the non-transitory computer-readable storage medium of memory 212 stores the following programs, modules, and data structures, or a subset or superset thereof:
an operating system 216 that includes procedures for handling various basic system services and for performing hardware-dependent tasks;
network communication module(s) 218 for connecting the client 104 to other computing devices (e.g., server system 102) via the one or more network interface(s) 210 (wired or wireless);
a user interface module 220 that receives commands and/or inputs from a user 102 via the user interface 204 (e.g., from input devices 208), and provides outputs for display by the user interface 204 (e.g., the output devices 206); and
one or more client application modules 222, including the following modules (or sets of instructions), or a subset or superset thereof:
   a web browser module 224 (e.g., Internet Explorer or Edge by Microsoft, Firefox by Mozilla, Safari by Apple, or Chrome by Google) for accessing, viewing, and interacting with web sites (e.g., a web-based service provided by the server system 300);
   a social media application module 226 for accessing, viewing, and interacting with social media services, including the following modules (or sets of instructions) or a subset or superset thereof:
      authentication module 228, for authenticating a user 106 (FIG. 1); and/or
      a software developer's kit (“SDK”) module 229, for providing functions that can be called by other applications, such as other client application modules 230;
   optional client application modules 230, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D gaming, virtual reality, electronic book reader, and/or workout support;
   an application module 232 for providing functions for a service hosted on a server system 300 (FIG. 3), including the following modules (or sets of instructions), or a subset or superset thereof:
      login module 234, for processing data entered by a user 106 (FIG. 1) to permit the user to log into the service and/or access certain functions of the service;
and/or optional client data modules 250, including the following storage modules (or sets of instructions), or a subset or superset thereof:
   cookie database 252 for storing cookies, such as those placed on the client device by server systems 300 (FIG. 3) or through client application modules 222, such as a web browser module 224;
   user information database 254 for storing user data; and/or
   media storage 260, for storing media content.

Although FIG. 2 illustrates the client devices 200 in accordance with some implementations, FIG. 2 is intended more as a functional description of the various features that may be present in one or more client devices 200 than as a structural schematic of the implementations described herein. In practice, items shown separately could be combined and some items could be separated.

FIG. 3 is a block diagram illustrating an exemplary server system 300 in accordance with some implementations. The server system 300 typically includes one or more central processing units/cores (CPUs) 302, one or more network interfaces 304, memory 306, and one or more communication buses 308 for interconnecting these components.

Memory 306 includes high-speed random access memory, such as DRAM, SRAM, DDR RAM, or other random access solid-state memory devices; and may include non-volatile memory, such as one or more magnetic disk storage devices, optical disk storage devices, flash memory devices, or other non-volatile solid-state storage devices. Memory 306, optionally, includes one or more storage devices remotely located from one or more CPUs 302. Memory 306, or, alternatively, the non-volatile solid-state memory device(s) within memory 306, includes a non-transitory computer-readable storage medium. In some implementations, memory 306, or the non-transitory computer-readable storage medium of memory 306, stores the following programs, modules and data structures, or a subset or superset thereof:
an operating system 310 that includes procedures for handling various basic system services and for performing hardware dependent tasks;
a network communication module 312 that is used for connecting the server system 300 to other computing devices (e.g., clients 104 and/or other server systems 300) via one or more network interfaces 304 (wired or wireless) connected to one or more networks 112 such as the Internet, other WANs, LANs, PANs, MANs, VPNs, peer-to-peer networks, content delivery networks, ad-hoc connections, and so on;
one or more server application modules 314 for enabling the server system 300 to perform various functions, the server application modules 314 including, but not limited to, one or more of:
   an authentication module 316, for authenticating users, including the following modules (or sets of instructions) or a subset or superset thereof:
      cryptography module 318, for encrypting and decrypting data;
      web service interface module 320, for interfacing with the various webpage-based services that seek to authenticate users and be informed of what user 106 (FIG. 1) is currently logged in; and/or
      client application interface module 322, for interfacing with the various client application-based services that seek to authenticate users and be informed of what user 106 (FIG. 1) is currently logged in;
   an application service module 324, for providing service to one or more users 106 or clients 104, including the following modules (or sets of instructions) or a subset or superset thereof:
      login/authentication module 326, for processing login requests from users 106;
   a cookie reading module 327 for reading and parsing cookies, such as those stored on client devices 200;
   a web server module 328 for providing web pages to client devices 200 or other server systems 300, such as through providing code (e.g., HTML and/or JavaScript) to client devices 200 or other server systems 300;
   and/or one or more server data module(s) 330 for handling the storage of and access to content, including but not limited to:
      an optional user database 332 for storing user data, including in some embodiments, user identifiers, identifiers for client devices 104, login names, names, passwords, characteristics, groups, and/or statuses;
      an optional credentials database 334 for storing information related to user login credentials;
      an optional web page storage 336 for storing data related to web pages, including, in some embodiments, web page source code, web page generation code, and/or cookies,
      optional media storage 338 for storing, in some embodiments, media content; and
      optional application service content 339 for storing information related to the content of an application service module 324.

The optional user database 332 stores user data, including in some embodiments, user identifiers, identifiers for client devices 104, login names, names, passwords, and/or statuses. The user identifiers, login names, and/or identifiers for client devices 104 are used by authentication module 316 and/or application service module 324 to associate data with users. For example, the user database 332 may associate an email address or phone number with a particular user 106. This data may be used by application service module 324 to determine what content to provide to the user. This data may be used by authentication module 316 to authenticate a user based on, for example, an email address or phone number (e.g., along with other data accessible to authentication module 316).

The optional credentials database 334 stores information related to user credentials. Credentials may, in some embodiments, include names, usernames, login names, email addresses, phone numbers, identifiers for client devices 104, birthdates, login time records, or other identifiers related to users 106. The data stored in credentials database 334 may be encrypted, such as by cryptography module 318.

The optional media store 338 stores, in some embodiments, media content including images, sounds, videos, and/or the like, that may be used by an application service module 324. Metadata may also be stored along with the content. In some embodiments, the metadata may specify whether the content is accessible to all users or a subset of users (such as logged-in users).

The optional application service content 339 stores, in some embodiments, content related to application service module 324. Metadata may also be stored along with the content. In some embodiments, the metadata may specify whether the content is accessible to all users or a subset of users (such as logged-in users).

The optional web page storage 336 stores, in some embodiments, web page source code, web page generation code, cookie generation code, pixel generation code, and/or records of IP addresses of client devices 104. The web page storage 336 is used by the optional web server module 328 to provide web pages to client devices 104. For example, web server module 328 may pull web page source code (e.g., HTML and/or JavaScript code) from web page storage 336 and transmit that code to a client device 104. In some embodiments, web server module 328 reads web page generation code from the web page storage 336 and uses this code to dynamically generate web page source code, allowing web server module 328 to create multiple versions of a web page.

In some implementations, web server module 328 comprises web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), Python, XHP, Javelin, Wireless Universal Resource File (WURFL), and the like.

In some embodiments, authentication module 316 is used to permit a user 106 (FIG. 1) to log into a service. In some embodiments, web service interface module 320 will interface with a web-based service, such as a service whose content is provided to client devices 200 by web server module 328 and is designed to be displayed on a browser module 224 (FIG. 2). In some embodiments, client application interface module 322 will interface with a client-application based service, such as a service whose content is provided to client devices 200 through an application (e.g., an “app”) on the client devices, such as a client application module 222. In some embodiments, a service may interface with both browser-based and application-based clients. Authentication module 316, in some embodiments, will authenticate a user based on one or more credentials such as a username combined with one or more passwords or access codes. In some embodiments, authentication module 316 will authenticate a user based upon a public identifier, such as an email address or phone number, combined with some other data which identifies the user 106. An example of such data may include user data in a cookie stored on the user's client device 200. Another example may include user data associated with a trusted application on client 200, such as a social media application module 226.

In some embodiments, application service module 324 provides content to users. In some embodiments, application service module 324 comprises a game. In some embodiments, it may comprise a news service, a social media service, an e-commerce service, and/or any other service. Application service module 324 may contain a login/authentication module 326 to permit a user 106 to log in to the service. Login/authentication module 326 may interact with an authentication module 316 on the same server system 300 or on a different server system 300 to complete the authentication of a user and log the user onto the service provided by application service module 324.

Although FIG. 3 illustrates the server system 300 in accordance with some implementations, FIG. 3 is intended more as a functional description of the various features that may be present in one or more server systems than as a structural schematic of the implementations described herein. In practice, items shown separately could be combined and some items could be separated. For example, some items shown separately in FIG. 3 could be implemented on single servers and single items could be implemented by one or more servers. The actual number of servers used to implement the server system 300, and how features are allocated among them, will vary from one implementation to another and, optionally, depends in part on the amount of data traffic that the server system handles during peak usage periods as well as during average usage periods.

Each of the above identified modules stored in memory 212 (FIG. 2) and 306 (FIG. 3) corresponds to a set of instructions for performing a function described herein. The above identified modules or programs (i.e., sets of instructions) need not be implemented as separate software programs, procedures, or modules, and thus various subsets of these modules may be combined or otherwise re-arranged in various implementations. In some implementations, memory 212 and 306 optionally store a subset or superset of the respective modules and data structures identified above. Furthermore, memory 212 and 306 optionally store additional modules and data structures not described above.

Each of the client data modules 250 and server data modules 330 stores data associated with client device 200 or server system 300 in one or more types of databases or data files, such as text, graph, dimensional, flat, hierarchical, network, object-oriented, distributed, relational, and/or XML, databases.

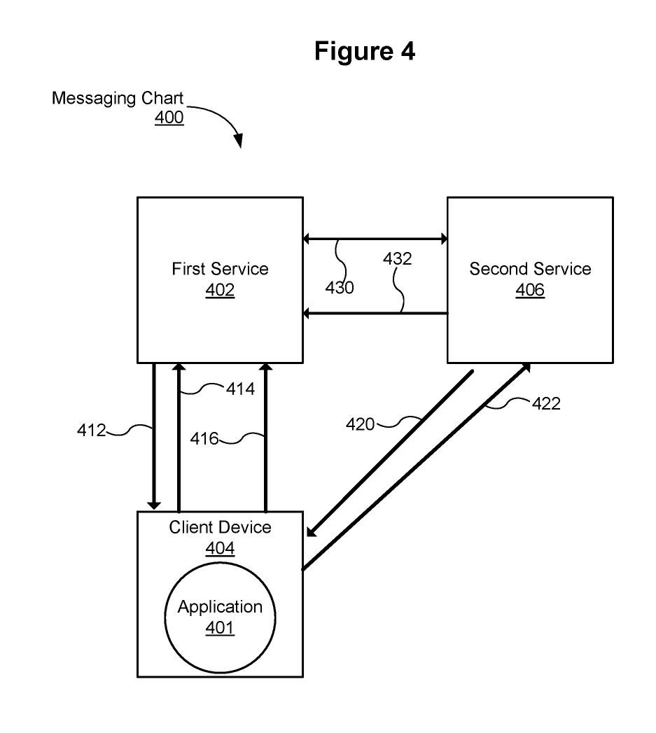

FIG. 4 is a chart illustrating messaging between a server system for a first service 402 being logged into, a server system for a second service 406 whose account is being used to log into the first service 402, and a client device 404 (e.g., client device 104, FIG. 1; 200, FIG. 2), in accordance with some embodiments. A user 106 (FIG. 1) uses an application 401 on client device 404 for the first service 402. The application 401 receives a request to authenticate the user 106 to the first service 402. For example, on a web-based system, this may be a pop-up window asking the user to log in in order to access certain functionality of the service.

In response to this request, application 401 may transmit (414) an identifier to the first service 402 and may request the first service 402 to authenticate user 106 based on the identifier and other data stored on client device 404. This identifier may be, for example, an email address or a phone number, or other publically-available information that is associated with the user 106.

In some embodiments, the first service 402 messages the second service 406 and exchanges information (430) related to user 106, client 404, and/or application 401. This messaging 430 may also include information related to the services (i.e., first service 402 and second service 406) such that the services can trust each other.

In some embodiments, the second service 406 sends a request (420) for the data stored on the client device 404. In response, the application 401 (or another application on client 404) may provide (422) the requested data to the second service 406. The second service 406 then notifies the first service 402 that user 106 is authenticated, allowing the first service 402 to log the user on and provide certain features of the service available to logged-in users.

It will be appreciated that messaging chart 400 illustrates only certain implementations. Other embodiments may have more or less messaging. Further, some embodiments may have messaging being routed through other systems. For example, rather than communicate directly (such as through two-way messaging 430), the first service system 402 and second service system 406 may communicate through an intermediary system on a network 112 (FIG. 1). In some embodiments, that system could be client device 404.

In some embodiments, the first and second services 402 and 406 could be co-located on a single server system. In some embodiments, the first service 402 and/or the second service 406 may be split among multiple servers.

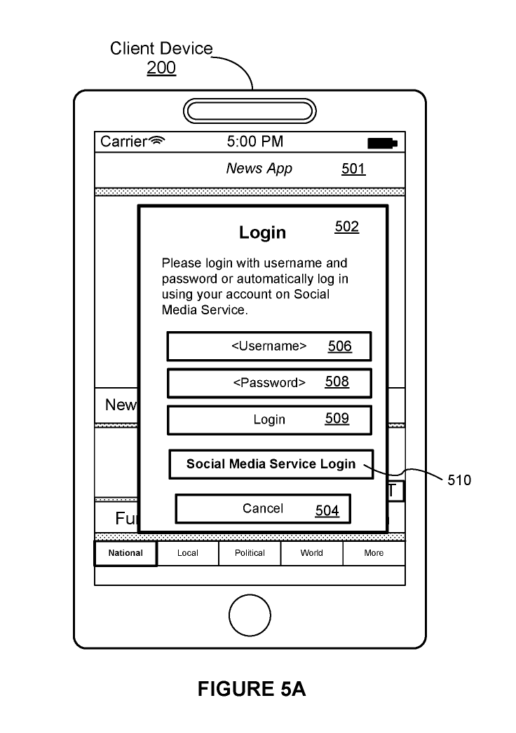

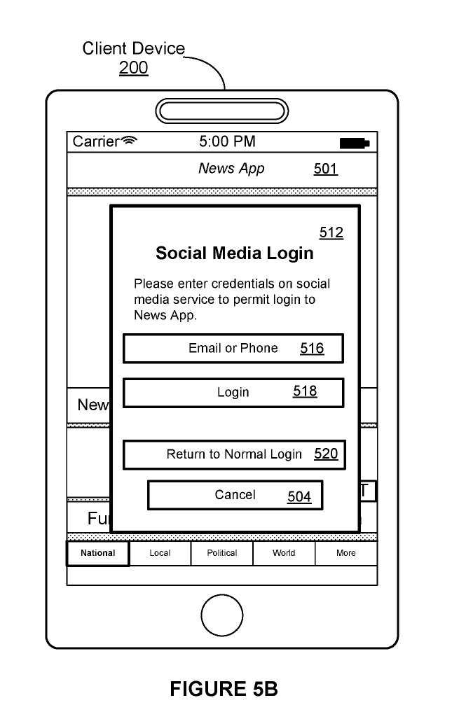

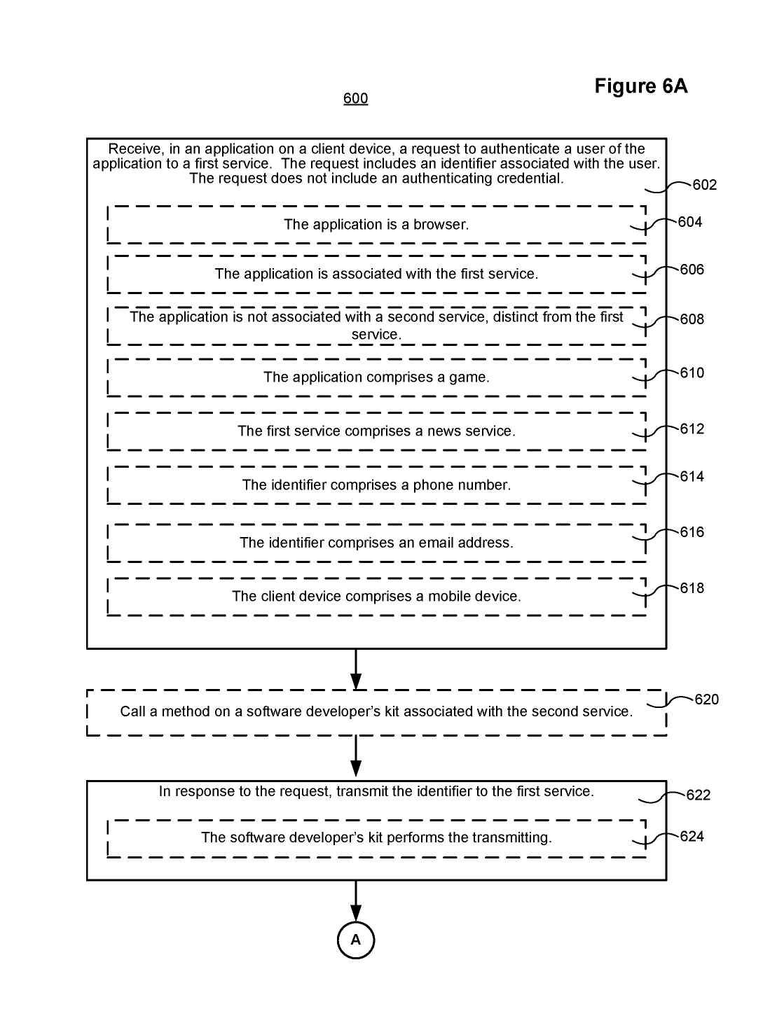

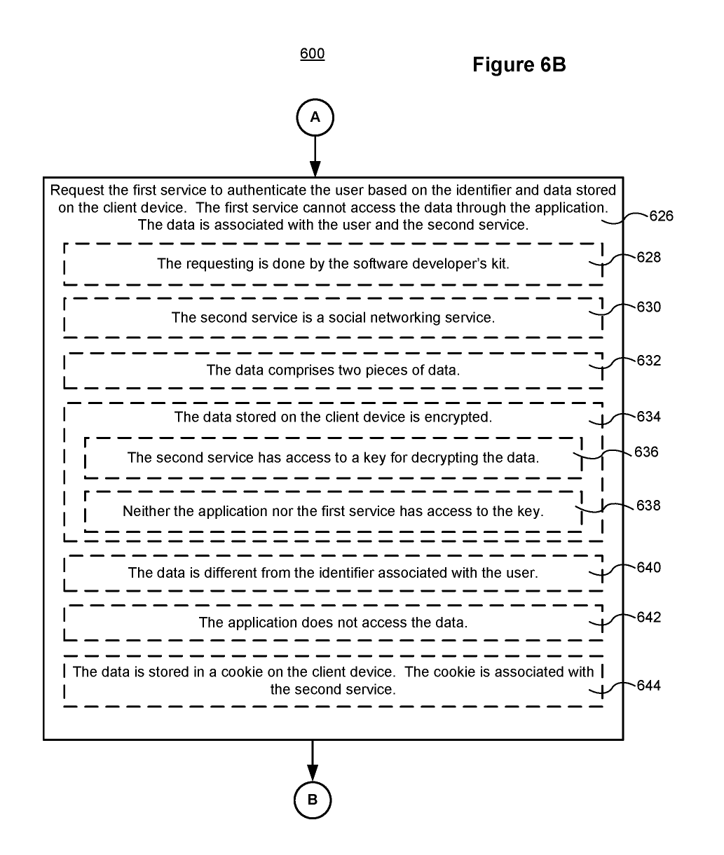

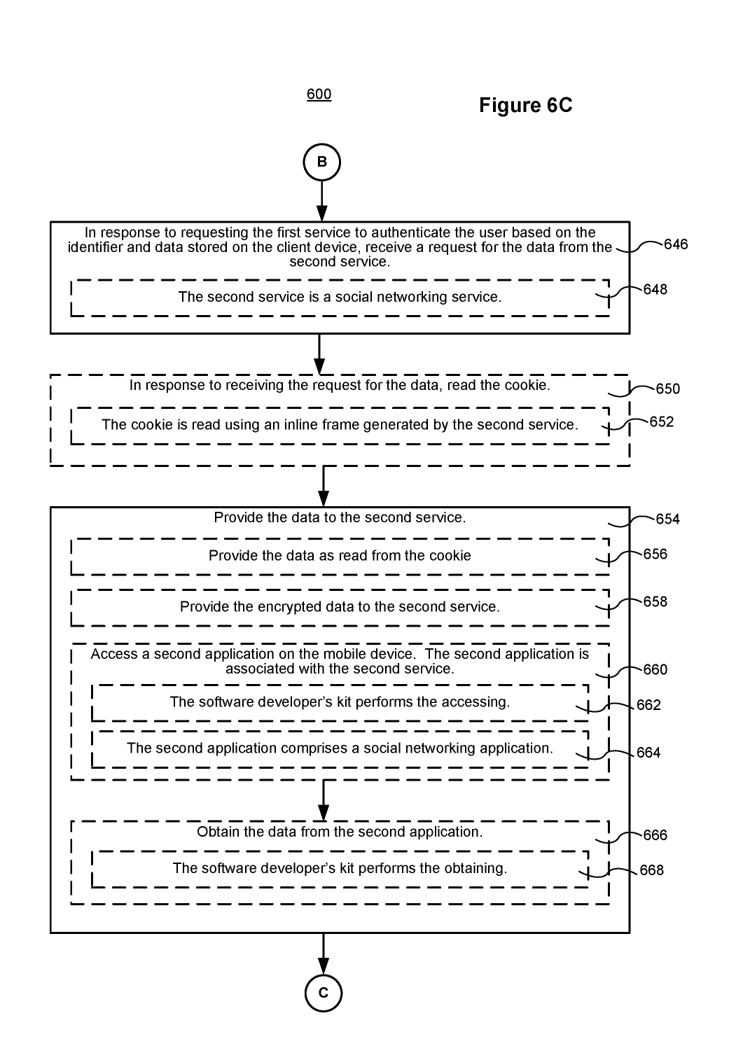

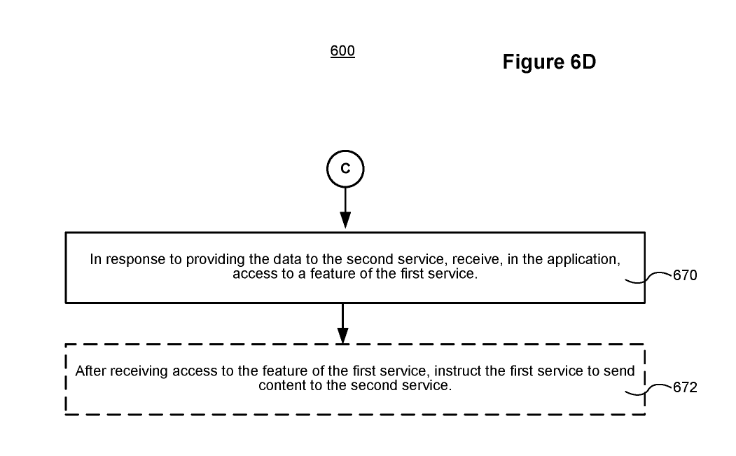

FIGS. 5A and 5B show an exemplary GUI of a login session as experienced by a user 106 (FIG. 1) on a client device 200 (FIG. 2), in accordance with some embodiments. The GUIs in these figures are used to illustrate certain features of the processes described below, including the method 600 (FIGS. 6A-6D). While FIGS. 5A-5B illustrate examples of GUIs, in other embodiments, one or more GUIs display user-interface elements in arrangements distinct from the embodiments of FIGS. 5A-5B.

FIG. 5A shows a login window 502 on an application 501 running on a mobile phone. Other embodiments may include other client devices 200, such as a computer and may comprise other ways of allowing a user 106 to interact with a service, such as through a web browser 224 (FIG. 2). The login window 502 requests that a user 106 log in to the app 501. Multiple login options may be provided. In some embodiments, the user 106 can login by entering a username 506 and a password 508 and selecting login 509. Alternatively, the user 106 can log in by selecting social media service login 510 which permits the user to log into the application 501 using an account associated a the social media service that is distinct from the application 501. Accordingly, the user 106 can log into application 501 even if the user does not have (or does not wish to use) an account on application 501, provided the user has an account on the social media service. A cancel option 504 may also be provided, which will allow the user to abort the login process.

When the user 106 clicks on social media service login 510, the user is presented with social media login screen 512 (FIG. 5B). In some embodiments, the user can enter a non-confidential identifier, such as an email address or a phone number in box 516 and then click login 518 to log into the service associated with application 501 using the user's account associated with the social media service. In some embodiments, in the event the user 106 does not wish to log in using the user's social media account, an option 520 to return to the username/password login screen and/or a cancel option 504 may be provided.

After the user clicks login 518, the user 106 will be logged into the service associated with application 501 using the user's account on the social media service. An exemplary process that permits this login and other logins is described in detail with respect to FIG. 6. Similarly, exemplary messaging to permit this login and other logins was described above with respect to FIG. 4.

FIGS. 6A-6D are flow diagrams illustrating a method 600 of providing a frictionless login into a first service using a user account associated with a second service, in accordance with some embodiments.

The steps of the method 600 may be performed by any combination of one or more server systems 102 (e.g., server systems 300) and client devices 104 (e.g., client devices 200). FIG. 6 corresponds to instructions stored in computer memory (e.g., memory 212 of the client device 200, FIG. 2; memory 306 of the server system 300, FIG. 3; and/or other computer-readable storage medium).

An application, such as application 401 (FIG. 4) (e.g., application module 232, FIG. 2), on a client device 200, receives (602) a request to authenticate a user 106 (FIG. 1) of the application 401 to a first service 402.

In some embodiments, the client device 200 comprises a mobile device (618), such as a tablet or smartphone. In some embodiments, the client device 200 comprises a computer, such as a laptop or desktop computer. In some embodiments, the application is a browser (604), such as browser module 224 (FIG. 2). In some embodiments, the application comprises a game (610). In some embodiments, the application is associated with the first service (606). In some embodiments, the first service comprises a news service (612), an image sharing service, a blogging platform, or another type of online service. In some embodiments, the application 401 is not associated with a second service (608), such as a service on second service system 406. In some embodiments, the first and second services are distinct services. In some embodiments, the first service and the second service are located on separate server systems 300 (FIG. 3), as shown in FIG. 4.

The request includes an identifier associated with user 106. In some embodiments, the identifier comprises a phone number (614). In some embodiments, the identifier comprises an email address (616). In some embodiments, the identifier comprises other information regarding user 106, which may be publically accessible. The request does not include an authenticating credential (e.g., a password or authentication code).

In some embodiments, the application 401 calls (620) a method provided by a software developer's kit (“SDK”), such as software developer's kit module 229, associated with the second service 406. The SDK may be resident on client device 200 (FIG. 2) or may be a remote method call to a server system 300 (FIG. 3) or other system. In some embodiments, the SDK may be a component of a social media application, such as social media application module 226, resident on client device 200.

In response to the request, the application 401 transmits (622) the identifier to first service 402. In some embodiments, the SDK performs the transmitting (624).

The application 401 requests (626, FIG. 6B) the first service 402 to authenticate the user 106 based on the identifier and data stored on client device 200. In some embodiments, the requesting is done by the SDK (628). The first service 402 cannot access the data through application 401. The data is associated with user 106 and with the second service 406. In some embodiments, the second service is a social networking service (630). In some embodiments, the data comprises two pieces of data (632). In some embodiments, the data is different from the identifier associated with the user 106 (640).

In some embodiments, the data stored on client device 200 is encrypted (634). For example, the data may have been placed on the client device 200 by a web server 328 (FIG. 3) using a web browser 224 (FIG. 2) on the client. For example, the data may be stored (644) as a cookie, such as in cookie database 252, on client device 200. The cookie may be associated with the second service 406. To ensure that other users of web browser 224 on client device 200 cannot access the data stored in cookie database 252, the second service 406 may encrypt the data using any well-known cryptographic method. For another example, the data may be associated with a custom application associated with second service 406, such as a social media application module 226 running on client device 200, and be stored in a user information database 254. The custom application is distinct from the application 401. To prevent a user with a file exploring program from accessing the data stored in user information database 254, either second service 406 or social media application module 226 may encrypt the data. In some embodiments, the second service 406 has access to a key for decrypting the data (636). In some embodiments, neither the application 401 nor the first service 402 has access to the key (638).

In some embodiments, the application 401 does not access (642) the data. For example, as described previously with respect to FIG. 4, a second application associated with the second service 406 (such as a social media application module 226, FIG. 2) may access the data and transmit the data to second service 406.

In response to requesting the first service 402 to authenticate the user 106 based on the identifier and the data stored on client device 200, the client device receives (646, FIG. 6C) a request for the data from the second service 406. In some embodiments, the second service is a social media service (648). In some embodiments, the second service is an email hosting service.

Where the data is stored in a cookie, such as in cookie database 252 (FIG. 2), in response to receiving the request for the data, the cookie is read (650). As described above, the cookie could be read by browser module 224, by a social media application module 226, or by another client application module 230. In some embodiments, the cookie is read using an in-line frame (652) generated by the second service 406. In some embodiments, for security, the cookie will be read over a secured protocol, such as HTTPS.

The client device provides (654) the data to the second service 406. In some embodiments, where the data is stored as a cookie, the application 401 provides the data as read from the cookie (656). For example, where the application 401 is a browser module 224 (FIG. 2) and the data is stored in cookie database 252, the browser module 224 reads the cookie from cookie database 252 and provides the data contained in the cookie (along with potentially additional data) to second service 406. If the data is encrypted on client device 200, the client device provides the encrypted data to the second service 406 (658). In some embodiments, the data will be provided over a secure protocol, such as HTTPS or another SSL or TLS-based protocol. In some embodiments, a second application is accessed (660) on the mobile device 200 that is associated with the second service 406. For example, the second application may be a client application module 230. In some embodiments, the SDK performs the accessing (662). In some embodiments, the second application comprises a social networking application (664), such as social media application module 226.

The client device obtains (666) the data from the second application. In some embodiments, this may involve requesting the data from the second application. In some embodiments, it may involve accessing a database associated with the second application, such as a user information database 254. In some embodiments, the SDK performs the obtaining (668).

In response to providing the data to the second service 406, the application 401 receives (670, FIG. 6D) access to a feature of the first service 402. For example, where the first service 402 is a news service (e.g., as illustrated in FIGS. 5A and 5B), accessing the feature may include accessing certain news articles that are otherwise inaccessible. The feature may also include the ability to comment or otherwise interact with the news articles. For another example, where the first service 402 is a game service, the feature may include the ability to save the user's game or to have the user's high score recorded or shared on another service, such as the second service 406. Other examples are possible.

In some embodiments, after receiving access to the feature of the first service 402, the application 401 instructs (672) the first service 402 to send content to the second service 406. For example, if the first service 402 is a game service and the second service 406 is a social media service, the application 401 may instruct first service 402 to post a screen shot of the game and/or the user's 106 high score to the social media service. Similarly, if the first service 402 is a news service and the second service is a social media service, the application 401 may instruct the news service to share a news story on the social media service. Other examples are possible.

Although some of the various drawings illustrate a number of logical stages in a particular order, stages that are not order dependent may be reordered and other stages may be combined or broken out. Furthermore, in some implementations, some stages may be performed in parallel and/or simultaneously with other stages. While some reordering or other groupings are specifically mentioned, others will be apparent to those of ordinary skill in the art, so the ordering and groupings presented herein are not an exhaustive list of alternatives. Moreover, it should be recognized that the stages could be implemented in hardware, firmware, software, or any combination thereof.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

What is claimed is:

1. A method, comprising:
on a client device having one or more processors and memory storing instructions for execution by the one or more processors:
receiving, in an application, a request to authenticate a user of the application to a first service, wherein the request includes an identifier associated with the user and does not include an authenticating credential;
in response to the request, transmitting the identifier to the first service;
requesting the first service to authenticate the user based on the identifier and data stored on the client device, wherein:
the first service cannot access the data through the application, and
the data is associated with the user and a second service distinct from the first service;
in response to the requesting, receiving a request for the data from the second service and providing the data to the second service; and
in response to providing the data to the second service, receiving, in the application, access to a feature of the first service.

2. The method of claim 1, further comprising, on the client device, after receiving access to the feature of the first service, instructing the first service to send content to the second service.

3. The method of claim 1, wherein the second service is a social networking system.

4. The method of claim 1, wherein:
the application is a browser; and
the data is stored in a cookie on the client device, wherein the cookie is associated with the second service.

5. The method of claim 4, further comprising, in the application on the client device, in response to receiving the request for the data, reading the cookie;
wherein providing the data to the second service comprises providing the data as read from the cookie.

6. The method of claim 5, wherein the cookie is read using an inline frame generated by the second service.

7. The method of claim 1, wherein:
the data stored on the client device is encrypted;
providing the data to the second service comprises providing the encrypted data to the second service;
the second service has access to a key for decrypting the data; and
neither the application nor the first service has access to the key.

8. The method of claim 1, wherein the data comprises two pieces of data.

9. The method of claim 1, wherein the data is different from the identifier associated with the user.

10. The method of claim 1, wherein:
the application is associated with the first service; and
the application does not access the data.

11. The method of claim 10, wherein:
the client device comprises a mobile device;
the application is a first application and is not associated with the second service; and
providing the data comprises:
accessing a second application on the mobile device, wherein the second application is associated with the second service; and
obtaining the data from the second application.

12. The method of claim 11, wherein the data is different from the identifier associated with the user.

13. The method of claim 11, further comprising, on the client device, calling a method on a software developer's kit (“SDK”) associated with the second service, wherein the SDK performs the transmitting, requesting, accessing, and obtaining.

14. The method of claim 11, wherein:
the second service is a social networking service;
the second application comprises a social networking application.

15. The method of claim 10, wherein the application comprises a game.

16. The method of claim 1, wherein the first service comprises a news service.

17. The method of claim 1, wherein the identifier comprises a phone number.

18. The method of claim 1, wherein the identifier comprises an email address.

19. A client device including one or more processors and memory storing one or more programs configured to be executed by the one or more processors, the one or more programs including instructions for:
receiving, in an application, a request to authenticate a user of the application to a first service, wherein the request includes an identifier associated with the user and does not include an authenticating credential;
in response to the request, transmitting the identifier to the first service;
requesting the first service to authenticate the user based on the identifier and data stored on the client device, wherein:
the first service cannot access the data through the application, and
the data is associated with the user and a second service distinct from the first service;
in response to the requesting, receiving a request for the data from the second service and providing the data to the second service; and
in response to providing the data to the second service, receiving, in the application, access to a feature of the first service.

20. A non-transitory computer readable storage medium storing one or more programs for execution by one or more processors of a client device, the one or more programs including instructions for:
receiving, in an application, a request to authenticate a user of the application to a first service, wherein the request includes an identifier associated with the user and does not include an authenticating credential;
in response to the request, transmitting the identifier to the first service;
requesting the first service to authenticate the user based on the identifier and data stored on the client device, wherein:
the first service cannot access the data through the application, and
the data is associated with the user and a second service distinct from the first service;
in response to the requesting, receiving a request for the data from the second service and providing the data to the second service; and
in response to providing the data to the second service, receiving, in the application, access to a feature of the first service.
